(19) United States
(12) Patent Application Publication
(10) Pub. No.: US 2006/0185079 A1
(43) Pub. Date: Aug. 24, 2006

(54) Folding chair cot for use with emergency vehicles

(76) Inventor: Nathan R. Walkingshaw, Sandy, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/062,646

(22) Filed: Feb. 22, 2005

(51) Int. Cl. A61G 7/10

(52) U.S. Cl. 5/86.1

(57) ABSTRACT

The present invention relates to a collapsible emergency vehicle chair cot that includes a support system and a movement system. The support system is a retractable system disposed on the bottom of the cot to support the chair cot during transportation. For example, one embodiment of a support system includes a track that extends from the bottom for the chair cot. The track supports the chair cot thereby minimizing the need for an emergency worker to manually support the chair cot during transportation. The movement system is coupled to the support system and utilizes rotational movement to assist in moving the chair cot over a surface. For example, one embodiment of a movement system includes coupling a motor system and a brake system to the support system to provide motorized movement. The support system and movement system are configured to be collapsible to facilitate using the chair cot with an emergency vehicle. The chair cot further includes at least two platforms for supporting a patient in a seated position.

### BACKGROUND

1. Field of the Invention

The present invention relates to a cot, and in particular to a collapsable emergency vehicle chair cot including a support system and a movement system.

2. Background

Cots are used to transport incapacitated or injured individuals from one location to another. For example, EMTs typically transport emergency medical patients from one location into their ambulances using cots. Early cots merely consisted of cloth stretched between two poles. A patient was positioned on the cloth and two emergency workers carry either end of the poles thereby supporting the patient. The primary problem with this design is that it requires two emergency workers to use both of their hands to transport their patient. This is problematic because emergency workers typically carry equipment and may need to perform tasks on the patients while being transported. Later, wheels were added to rigid cots to make gurneys which are easier for emergency workers to move patients from a particular location into an emergency vehicle. These added wheels allowed patients to easily be wheeled across flat surfaces to an emergency vehicle. The added wheels are also configured to collapse such that the cot could be properly fitted into an emergency vehicle and serve as a bed during transportation to a hospital. Additional wheels were eventually added to the loading end of cots in order to minimize friction and facilitate wheeling the cot into an emergency vehicle.

While these wheeled gurney embodiments provide significant advantages over the traditional cloth type cots, there are still significant problems. For example, if the patient must be transported over uneven surfaces such as stairs, curbs, or inclines, the conventional wheeled gurney will still require at least two emergency workers to properly transport the patient. In addition, on steep and irregular inclines, it is very difficult to support and stabilize the uphill side of the wheeled cot because it will be disposed very close to the ground. Further, certain uneven surfaces may cause the cot to bounce or shift resulting in additional pain and possibly injury to the patient. Therefore, for at least these reasons there is a need in the industry for an improved cot.

### SUMMARY

The present invention relates to a collapsible emergency vehicle chair cot that includes a support system and a movement system. The support system is a retractable system disposed on the bottom of the cot to support the chair cot during transportation. For example, one embodiment of a support system includes a track that extends from the bottom for the chair cot. The track supports the chair cot thereby minimizing the need for an emergency worker to manually support the chair cot during transportation. The movement system is coupled to the support system and utilizes rotational movement to assist in moving the chair cot over a surface. For example, one embodiment of a movement system includes coupling a motor system and a brake system to the support system to provide motorized movement. The support system and movement system are configured to be collapsible to facilitate using the chair cot with an emergency vehicle. The chair cot further includes at least two platforms for supporting a patient in a seated position.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a profile view of a chair cot in accordance with one embodiment of the present invention;

FIG. 1B is a detailed view of the control system illustrated in FIG. 1A;

FIG. 1C is a detailed view of the collapsing mechanism attached to the arm rest illustrated in FIG. 1A;

FIG. 1D is a front view of the chair cot illustrated in FIG. 1A;

FIG. 2A is a profile view of an alternative embodiment of an expanded chair cot in accordance with the present invention;

FIG. 2B is a profile view of the chair cot illustrated in FIG. 2A in a collapsed configuration;

FIG. 2C is a front view of the expanded chair cot illustrated in FIG. 2A;

FIG. 2D is a perspective view of the expanded chair cot illustrated in FIG. 2A;

FIG. 3A is a perspective view of an alternative embodiment of an expanded chair cot in accordance with the present invention;

FIG. 3B is a profile view of the expanded chair cot illustrated in FIG. 3A; and

FIG. 3C is profile view of the chair cot illustrated in FIG. 3A in a collapsed configuration.

### DETAILED DESCRIPTION OF THE PREFERRED EMBODIMENTS

Reference will now be made to the drawings to describe presently preferred embodiments of the invention. It is to be understood that the drawings are diagrammatic and schematic representations of the presently preferred embodiments, and are not limiting of the present invention, nor are they necessarily drawn to scale.

The present invention relates to a collapsible emergency vehicle chair cot that includes a support system and a movement system. The support system is a retractable system disposed on the bottom of the cot to support the chair cot during transportation. For example, one embodiment of a support system includes a track that extends from the bottom for the chair cot. The track supports the chair cot thereby minimizing the need for an emergency worker to manually support the chair cot during transportation. The movement system is coupled to the support system and utilizes rotational movement to assist in moving the chair cot over a surface. For example, one embodiment of a movement system includes coupling a motor system and a brake system to the support system to provide motorized movement. The support system and movement system are configured to be collapsible to facilitate using the chair cot with an emergency vehicle. The chair cot further includes at least two platforms for supporting a patient in a seated position. Also, while embodiments of the present invention are directed to emergency vehicle chair cots, it will be appreciated that the teachings of the present invention are applicable to other fields.

The following terms are defined as follows:

“chair cot”—a device for transporting an individual in a sitting position from one location to an emergency vehicle. A chair cot may be configured to interface with a gurney for use in a hospital.

“gurney”—a wheelable bed device used in hospitals and other facilities to easily transport patients over flat surfaces.

“emergency vehicle”—any vehicle used to transport incapacitated individuals from one location to another including but not limited to ambulances, fire truck/engine, elderly car vehicles, helicopter, etc.

“patient”—any person or animal being carried by a cot, including but not limited to individuals and animals that are sick, elderly, injured, deceased, etc.

“emergency worker”—any individual who is responsible for moving an incapacitated individual from one location to an emergency vehicle, including but not limited to EMTs, firemen, ambulance drivers, doctors, paramedics, nurses, search and rescue, ski patrol, etc.

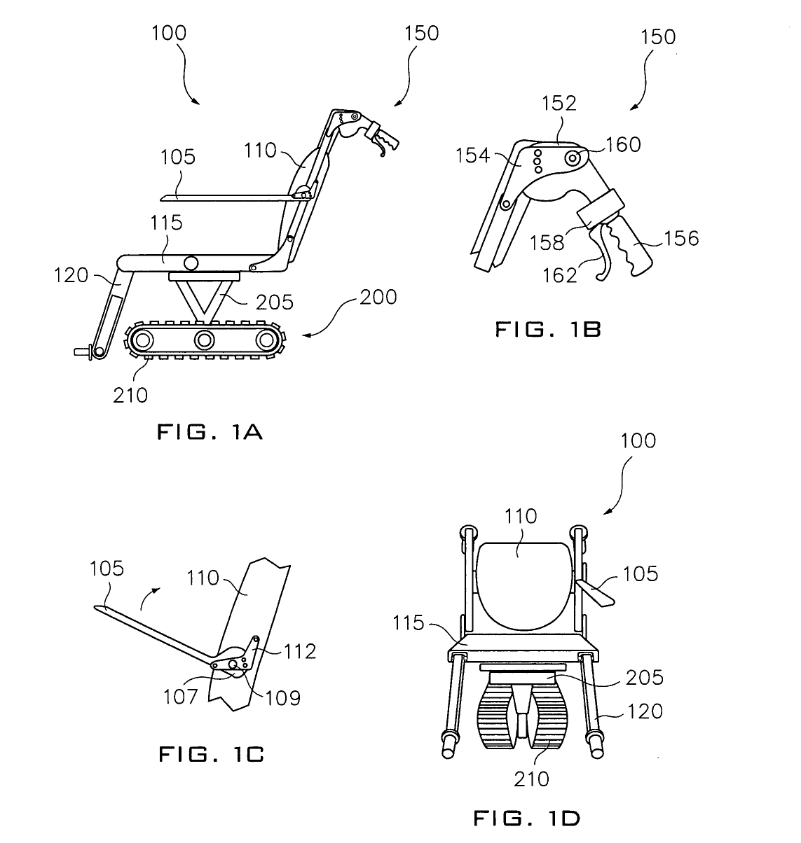

Reference is initially made to FIGS. 1A-1D, which illustrate various views of a chair cot in accordance with one embodiment of the present invention. The chair cot is designated generally at 100. The chair cot 100 is configured to expand and collapse into two primary configurations. In the expanded configuration (FIG. 1A and ID), a patient is able to be transported in a sitting position from one location to an emergency vehicle. In the collapsed configuration (not shown), the chair cot 100 can easily be stored in an emergency vehicle. The chair cot can be operated by a single emergency worker allowing a second emergency worker to perform medical functions on the patient. The chair cot 100 generally includes two control systems 150, a back support 110, an arm rest 105, a seat 115, a foot rest 120, and a support and movement system 200. These components operate together to provide the functionality of the chair cot 100.

The control systems 150 enable an emergency worker to operate the chair cot 100. This operation includes pushing, guiding, steering, and directing the chair cot 100 in the desired directions. In addition, the control system 150 is configured to control the movement of the chair cot 100 through the use of a braking system. This allows an operator to slow the descent of the chair cot 100 down a decline. An identical independent control system 150 is located on either side of the chair cot 100, for explanation purposes only one system will be described. The control system 150 further includes a handle 156, a brake attachment 158, a brake lever 162, a pivotable arm 152, a pivot bolt 160, and a pivot bracket 154. The handle 156, brake attachment 158, and brake lever 162 are all disposed on the pivotable arm 152 to allow for customization of the control system 150. For example, in some situations an emergency worker may wish to push the chair cot 100 up an incline and a lowered pivot arm 152 is preferable. Likewise, when transferring the chair cot 100 over a level surface, a substantially level pivot arm 152 may be optimal. The pivoting also allows the chair cot 100 to collapse. The pivot arm 152 also includes a pivot bolt 160 that extends through a hole in the pivot bracket 154. This allows the pivot arm 152 to pivot with respect to the pivot bracket 154. A locking pin and hole mechanism is also disposed on the pivot arm 152 and pivot bracket 154 to facilitate locking the pivot arm 152 in a particular configuration. The brake lever 162 is part of a braking system that is configured to slow and stop the rotational movement of the support and movement system 200.

The back support 110 is pivotally coupled to the control system 150, the arm rest 105, and the seat 115. This pivotable coupling allows for the chair cot 100 to be collapsed. Various pivoting systems may be used and remain consistent with the present invention. The back support 110 is configured to be positioned in a manner to provide support for a patient's back during transportation in a seated position. Likewise, the arm rest 105 is configured to provide support for a patient's arms during transportation and the seat is configured to provide lower support for a patient during transportation. A foot rest 120 is also pivotally coupled to the seat 115 to provide additional patient transportation configurations. The back support 110, arm rest 105, and seat 115 can be adjusted to various angles with respect to one another to create various seating configurations. FIG. 1C illustrates a pivoting mechanism between the back support 110 and the arm rest 105. The arm rest 105 is coupled to a pivot arm 107 that includes a pivot bolt 109. The pivot arm 107 is configured to rotate or pivot with respect to the pivot bolt 109. The pivot bolt 109 is also coupled to the pivot bracket 112 which is coupled to the back support 110. A locking pin and hole system is also utilized to releasably lock the pivot arm 107 in a particular configuration with respect to the pivot bracket 112. The pivot bracket 112 is coupled to the back support 110 as shown.

The support and movement system 200 includes a support system that provides support for the chair cot 100 and a movement system that allows the chair cot 100 to utilize rotational movement during transportation. The illustrated support and movement system 200 includes a V-shaped support bracket 205 coupled to a dual track 210. The dual track 210 acts like an elongated wheel to allow the chair cot 100 to translate utilizing rotational movement and support. The dual track 210 incorporates a ribbed track to facilitate ascending and descending stepped and irregular surfaces. The dual track 210 is configured to pivot or rotate with respect to the V-shaped bracket 205 to facilitate translation over irregular surfaces.

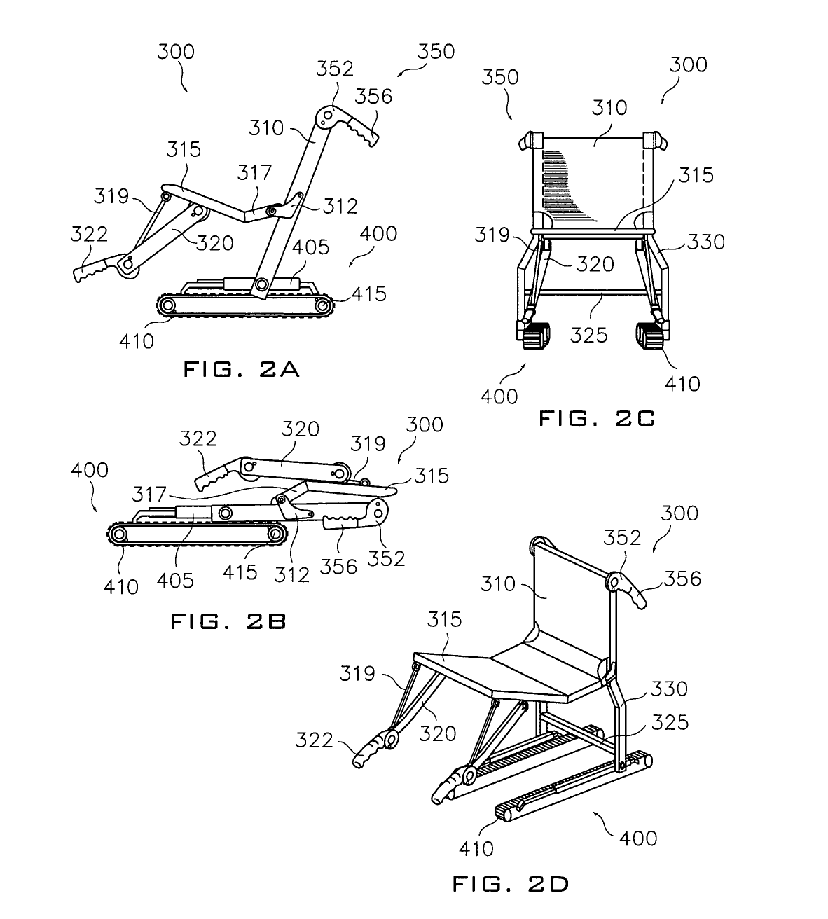

Reference is next made to FIGS. 2A-2D, which illustrate various views of an alternative embodiment of a chair cot in accordance with the present invention. The chair cot is designated generally at 300. The chair cot 300 is configured to expand and collapse into two primary configurations. In the expanded configuration (FIGS. 2A, 2C, and 2D), a patient is able to be transported in a sitting position from one location to an emergency vehicle. In the collapsed configuration (FIG. 2B), the chair cot 300 can easily be stored in an emergency vehicle. The chair cot can be operated by a single emergency worker allowing a second emergency worker to perform medical functions on the patient. The chair cot 300 generally includes two control systems 350, a back support 310, a seat 315, a foot rest 320, and a support and movement system 400. These components operate together to provide the functionality of the chair cot 400.

The control systems 350 enable an emergency worker to operate the chair cot 300. This operation includes pushing, guiding, steering, and directing the chair cot 300 in the desired directions. An identical independent control system 350 is located on either side of the chair cot 300, for explanation purposes only one system will be described. The control system 350 further includes a handle 356 and a pivotable arm 352. The handle 156 is disposed on the pivotable arm 352 to allow for customization of the control system 350. For example, in some situations an emergency worker may wish to push the chair cot 300 up an incline and a lowered pivot arm 352 is preferable. Likewise, when transferring the chair cot 300 over a level surface, a substantially level pivot arm 352 may be optimal. The pivoting functionality also allows for the chair cot 300 to collapse as shown in FIG. 2B. The pivot arm 352 includes a pivot bolt that extends through a hole in the back support 310. This allows the pivot arm 352 to pivot with respect to the back support 310. A locking pin and hole mechanism is also disposed on the pivot arm 352 and back support 310 to facilitate locking the pivot arm 352 in a particular configuration.

The back support 310 is pivotally coupled to the control system 350 and the seat 315. This pivotable coupling allows for the chair cot 300 to be collapsed. Various pivoting systems may be used and remain consistent with the present invention. The back support 310 is configured to be positioned in a manner to provide support for a patient's back during transportation in a seated position. Likewise, the seat is configured to provide lower support for a patient during transportation. A foot rest 320 is also pivotally coupled to the seat 315 to provide additional transportation configurations and foot support. In the illustrated embodiment, the foot rest 320 further includes a pivot bar 319 and a second handle 322. The pivot bar 319 provides additional support and stability to the foot rest 320. The second handle 322 is useful in transporting the chair cot 300 in the collapsed configuration, as shown in FIG. 2B. The back support 310, seat 315, and foot rest 320 can be adjusted to various angles with respect to one another to create various seating configurations. The seat 315 further includes a pivot arm 317 that utilizes a pivot bolt, pivot bracket, lock and pin type pivoting mechanism as described above.

The support and movement system 400 includes a support system that provides support for the chair cot 300 and a movement system that allows the chair cot 300 to utilize rotational movement during transportation. The illustrated support and movement system 400 includes a two support members 330, a support bar 325, a two track attachments 405, and two tracks 410. The support members 330 extend down from the back support 310 and are coupled to the track attachments 405. The support bar 325 extends between the support members 330 to provide lateral support and stability. The track attachments 405 are coupled to the tracks 410 in a manner to facilitate the rotational freedom of the tracks 410. The tracks 410 act like elongated wheels to allow the chair cot 300 to translate utilizing rotational movement and support. The tracks 410 each incorporate a ribbed track to facilitate ascending and descending stepped and irregular surfaces. The tracks 410 are configured to pivot or rotate with respect to the support members 330 to facilitate translation over irregular surfaces.

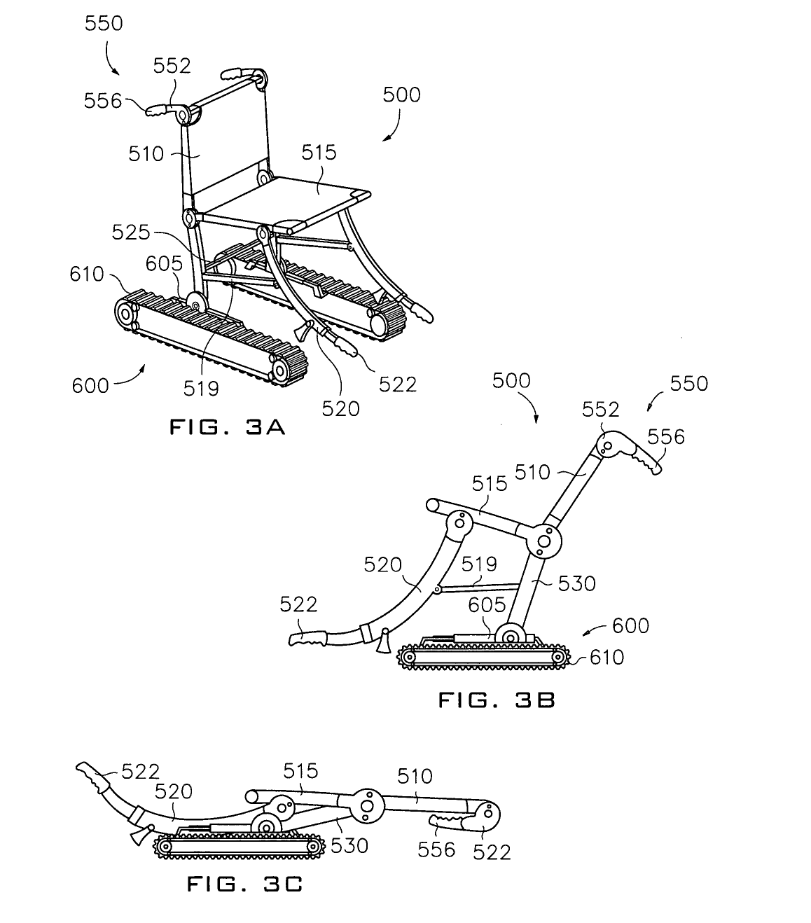

Reference is next made to FIGS. 3A-3C, which illustrate various views of an alternative embodiment of a chair cot in accordance with the present invention. The chair cot is designated generally at 500. The chair cot 500 is configured to expand and collapse into two primary configurations. In the expanded configuration (FIGS. 3A and 3B), a patient is able to be transported in a sitting position from one location to an emergency vehicle. In the collapsed configuration (FIG. 3C), the chair cot 500 can easily be stored in an emergency vehicle. The chair cot 500 can be operated by a single emergency worker allowing a second emergency worker to perform medical functions on the patient. The chair cot 500 generally includes two control systems 550, a back support 510, a seat 515, a foot rest 520, and a support and movement system 600. These components operate together to provide the functionality of the chair cot 500.

The control systems 550 enable an emergency worker to operate the chair cot 500. This operation includes pushing, guiding, steering, and directing the chair cot 500 in the desired directions. An identical independent control system 550 is located on either side of the chair cot 500, for explanation purposes only one system will be described. The control system 550 further includes a handle 556 and a pivotable arm 552. The handle 556 is disposed on the pivotable arm 552 to allow for customization of the control system 550. For example, in some situations an emergency worker may wish to push the chair cot 500 up an incline and a lowered pivot arm 552 is preferable. Likewise, when transferring the chair cot 500 over a level surface, a substantially level pivot arm 552 may be optimal. The pivoting functionality also allows for the chair cot 500 to collapse as shown in FIG. 3C. The pivot arm 552 includes a pivot bolt that extends through a hole in the back support 510. This allows the pivot arm 552 to pivot with respect to the back support 510. A locking pin and hole mechanism is also disposed on the pivot arm 552 and back support 510 to facilitate locking the pivot arm 552 in a particular configuration.

The back support 510 is pivotally coupled to the control system 550 and the seat 515. This pivotable coupling allows for the chair cot 500 to be collapsed. Various pivoting systems may be used and remain consistent with the present invention. The back support 510 is configured to be positioned in a manner to provide support for a patient's back during transportation in a seated position. Likewise, the seat is configured to provide lower support for a patient during transportation. A foot rest 520 is also pivotally coupled to the seat 515 to provide additional transportation configurations and foot support. In the illustrated embodiment, the foot rest 520 further includes a pivot bar 519 and a second handle 522. The pivot bar 519 provides additional support and stability to the foot rest 520. The second handle 522 is useful in transporting the chair cot 500 in the collapsed configuration, as shown in FIG. 3C. The back support 510, seat 515, and foot rest 520 can be adjusted to various angles with respect to one another to create various seating configurations. The seat 515 further includes a pivot arm 517 that utilizes a pivot bolt, pivot bracket, lock and pin type pivoting mechanism as described above.

The support and movement system 600 includes a support system that provides support for the chair cot 500 and a movement system that allows the chair cot 500 to utilize rotational movement during transportation. The illustrated support and movement system 600 includes a two support members 530, a support bar 525, a two track attachments 605, and two tracks 610. The support members 530 extend down from the back support 510 and are coupled to the track attachments 605. The support bar 525 extends between the support members 530 to provide lateral support and stability. The track attachments 605 are coupled to the tracks 610 in a manner to facilitate the rotational freedom of the tracks 610. The tracks 610 act like elongated wheels to allow the chair cot 500 to translate utilizing rotational movement and support. The tracks 610 each incorporate a ribbed track to facilitate ascending and descending stepped and irregular surfaces. The tracks 610 are configured to pivot or rotate with respect to the support members 530 to facilitate translation over irregular surfaces.

The movement systems of each embodiment may further include a motor to rotate the tracks without external force. The motor may be an electric motor coupled to some form of rechargeable and replaceable power source. The control systems of each embodiment may further include various motor controls to facilitate movement. The movement system must still conform to the dimensions of the chair cot embodiments such that it can be properly collapsed for transportation.

In operation, a chair cot in accordance with the present invention may be transported in a collapsed configuration to a patient in need of emergency services. The chair cot may then be expanded into the expanded configuration by locking various pivoting members into place. Adjustments to the pivotable angles may be made depending on the size and medical condition of the patient. The patient is then positioned in a seated position on the chair cot. The chair cot then utilizes rotational movement to transfer the patient to an emergency vehicle. The chair cot is then collapsed for storage within the emergency vehicle.

The present invention may be embodied in other specific forms without departing from its spirit of essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A chair cot configured for use with an emergency vehicle, comprising:
at least two platforms for supporting a patient in a seated position during transportation;
a support system coupled to the at least two platforms configured to support the at least two platforms during transportation; and wherein the support system is configured to substantially collapse when positioned within the emergency vehicle; and
a movement system coupled to the support system that is configured to allow the chair cot to move over a surface.

2. The chair cot of claim 1, wherein the support system includes a suspension system for minimizing impacts on a patient during transportation.

3. The chair cot of claim 1, wherein the movement system further includes a motor.

4. The chair cot of claim 3, wherein the motor is electric and further includes a power source.

5. The chair cot of claim 4, wherein the power source is a replaceable rechargeable battery.

6. The chair cot of claim 5, wherein the at least one rotational device includes at least two tracks.

7. The chair cot of claim 1, wherein the support system includes two tracks that extend below the cot.

8. The chair cot of claim 7, wherein the at least two tracks include protruding rubber ribs to allow for gripping stairs and other irregular surfaces.

9. The chair cot of claim 1, wherein the chair cot further includes a control system coupled to the at least one platform and the movement system that allows an individual to control the operation of the movement system.

10. The chair cot of claim 9, wherein the control system includes a braking system that steers, slows, and stops the rotational movement of the movement system when engaged.

11. The chair cot of claim 10, wherein the braking system is substantially mechanical.

12. The chair cot of claim 9, wherein the movement system further includes a motor and the control system includes a forward and reverse mechanism that allows the movement system to move forward and reverse respectively.

13. The chair cot of claim 1, wherein the movement system is designed to lock in the event that power is lost.

14. The chair cot of claim 1, wherein a motorized portion of the movement system can be disengaged thereby allowing for descent of an inclined surface utilizing non-motorized rotational movement.

15. A chair cot configured for use with an emergency vehicle, comprising:
at least two platforms for supporting a patient in a seated position during transportation;
a support system coupled to the at least two platforms configured to support the at least two platforms during transportation; and wherein the support system is configured to substantially collapse when positioned within the emergency vehicle; and
a movement system coupled to the support system that is configured to allow the chair cot to move over a surface, wherein the movement system includes a motor; and
a control system coupled to the at least one platform and the movement system that allows an individual to control the operation of the movement system, and wherein the control system includes at least one mechanical brake that is configured to steer, slow, and stop the rotational movement of the movement system when engaged.

16. A method of transporting a patient to an emergency vehicle comprising the acts of:
disposing the patient in to a supported seated position on a chair cot;
expanding the chair cot including engaging a support system below the chair cot;
engaging a movement system on the chair cot causing the chair cot to utilize rotational movement to translate over a surface;
directing the rotational movement of the chair cot to the emergency vehicle;
collapsing the chair cot to conform to the dimensions of an emergency vehicle; and
disposing the chair cot within the emergency vehicle.

17. The method of claim 16, wherein the act of disposing the patient in to a supported seated position on the chair cot further includes the acts of:
transporting the chair cot from the emergency vehicle to the patient; and
positioning the patient on to the cot in a supported seated position.

18. The method of claim 16, wherein the act of engaging a movement system on the cot further includes the act of operating a control system which causes a motor to generate rotational movement on the inclined end of the cot.

19. The method of claim 16, wherein the act of directing the rotational movement of the chair cot to the emergency vehicle, further includes the acts of:
operating a control system to direct the chair cot in the direction of the emergency vehicle;
operating a control system to overcome and avoid obstacles during translation of the chair cot to the emergency vehicle.

20. The method of claim 17, wherein the act of collapsing the chair cot to conform to the dimensions of an emergency vehicle further includes folding the support system and the movement system.
